(19) United States
(12) Patent Application Publication
(10) Pub. No.: US 2014/0002639 A1
(43) Pub. Date: Jan. 2, 2014

(54) Autonomous Detection of Chemical Plumes

(71) Applicants: Joseph M. Cheben, Boerne, TX (US); Yousheng Zeng, Baton Rouge, LA (US); Jon Morris, Baton Rouge, LA (US); Yanhua Ruan, Baton Rouge, LA (US)

(72) Inventors: Joseph M. Cheben, Boerne, TX (US); Yousheng Zeng, Baton Rouge, LA (US); Jon Morris, Baton Rouge, LA (US); Yanhua Ruan, Baton Rouge, LA (US)

(21) Appl. No.: 14/001,356

(22) PCT Filed: Mar. 12, 2012
(86) PCT No.: PCT/US12/28788

§ 371 Date: Aug. 23, 2013

Related U.S. Application Data
(60) Provisional application No. 61/467,816, filed on Mar. 25, 2011.
(60) Provisional application No. 61/509,909, filed on Jul. 20, 2011.

(51) Int. Cl. G06T 7/20

(52) U.S. Cl. CPC G06T 7/2033
USPC 348/135; 382/107

(57) ABSTRACT

Systems and methods for autonomously detecting a chemical plume are described. In a method for autonomously detecting a chemical plume, a plurality of images are obtained from a detection camera at least at a wavelength of light selected to be absorbed or emitted by a chemical species. The plurality of images is analyzed to identify changes in a deterministic feature, changes in a statistical feature, or both, between sequential images. A chemical plume is recognized based, at least in part, on the changes.

### CROSS-REFERENCE TO RELATED APPLICATION

This application claims priority from both U.S. Provisional Application No. 61/467,816, filed on Mar. 25, 2011, entitled Apparatus and Systems for Identifying Hydrocarbon Gas Emissions and Methods Related Thereto and U.S. Provisional Patent Application No. 61/509,909, filed Jul. 20, 2011, entitled Autonomous Detection for Chemical Plumes, both of which are incorporated by reference herein in their entirety.

### FIELD

The present techniques relate to apparatus and systems for identifying chemical emissions. More particularly, the disclosure is related to autonomous apparatus and systems that scan for and identify chemical emissions in facilities.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Hydrocarbon usage is a fundamental aspect of current civilization. Facilities for the production, processing, transportation, and use of hydrocarbons continue to be built in locations around the world. The efficiency of these plants become increasingly important, as even minor losses of hydrocarbons can add to cost or create issues for regulatory agencies.

Hydrocarbons may be lost or used before sale due to process limitations, process upsets leading to flaring, leaks, and usage of part of the hydrocarbons to fuel the process. While most of these issues can be directly improved by design, leaks can provide a challenge, as they may occur on any number of different process equipment types. For example, leaks can originate from pipe flanges, valves, valve stems, sampling systems, and any number of other locations. As equipment is used and ages, leaks become increasing probable.

Plant conditions may increase the probability of leakage or exacerbate leaks when they form. For example, plants used to generate liquefied natural gas (LNG) use high pressures and cryogenic temperatures, both of which can increase the probability of leaks. The number of LNG liquefaction plants around the world is growing rapidly. As these plants age, there is an increasing potential for hydrocarbon leaks to develop.

Early detection and repair of leaks can be useful in preventing any number of issues, such as increased costs and regulatory issues. Leaks may be detected by operators, for example, by seeing the release, smelling the hydrocarbons, or hearing noise caused by the release. However, most hydrocarbon vapors are not visible to the naked eye (e.g., to visual inspection by a person). Further, there is often a high level of equipment congestion in plants, which may place a leak point behind another piece of equipment. In addition, hydrocarbons may have a minimal odor and, thus, may not be detected by smell. Detecting a small leak by sound is improbable, as the very high level of ambient noise makes it unlikely that the leak may be heard.

Leak detection systems have been installed in many hydrocarbon facilities. These systems may include combustible gas detectors that monitor the concentration or lower explosive limit (LEL) of hydrocarbon vapors at a particular location, providing a measurement of a hydrocarbon level at a point in an area. An array of point measurement systems may then be used to track a vapor release across the area. However, point detection systems may not detect small releases, such as from small leaks or new leaks, the amount of hydrocarbons released, and the like.

Other leak detection systems have been used to detect hydrocarbons in a line across a plant environment, for example, by directing a light source at one edge of an area towards a spectroscopic detector at another edge of the area. While such systems may be useful for monitoring compliance for regulatory issues, they do not necessary identify a location of a release along the line. Further, they may not detect small releases at all for the same reasons as the point detectors, e.g., the hydrocarbons may be too dilute to detect, or may be blown away from the detection line by the wind.

Thus, depending on the location of a leak and a direction of a gas release relative to conventional gas detectors, leaks may remain undetected for some period of time. This may allow vapor clouds to develop, causing problems in the plant environment.

Systems have been developed to detect releases by imaging areas using hyperspectral cameras, which can directly show an image of a hydrocarbon plume. For example, Hackwell, J. A., et al., “LWIR/MWIR Hyperspectral Sensor for Airborne and Ground-based Remote Sensing,” Proceedings of the SPIE, Imaging Spectroscopy II, M. R. Descour, and J. M. Mooney, Eds., Vol. 2819, pp. 102-107 (1996), discloses an infrared imaging spectrograph which was first used as an airborne sensor in October, 1995. The instrument was named a spatially-enhanced broadband array spectrograph system (SEBASS). The SEBASS system was intended to explore the utility of hyperspectral infrared sensors for remotely identifying solids, liquids, gases, and chemical vapors in a 2 to 14 micrometers spectral region often used to provide a chemical fingerprint. The instrument is an extension of an existing non-imaging spectrograph that used two spherical-faced prisms to operate simultaneously in the atmospheric transmission windows found between 2.0 and 5.2 micrometers and between 7.8 and 13.4 micrometers (LWIR). The SEBASS system was used in March 1996 for a tower-based collection.

The SEBASS system allows the imaging and identification of chemical materials, such as plumes, in an environment. However, it was not used for autonomous identification of chemical releases. Without an autonomous monitoring system, the images have to be manually examined by a person, making fast identification problematic. Further, the complexity of the system itself could make continuous autonomous usage problematic.

In a presentation entitled “The Third Generation LDAR (LDAR3) Lower Fugitive Emissions at a Lower Cost” (presented at the 2006 Environmental Conference of the National Petrochemical & Refiners Association, Sep. 18-19, 2006), Zeng, et al., disclosed an autonomous system for leak identification that used a camera to identify leaks in a particular area of a plant. Any leaks may be automatically recognized by software that processes infrared (IR) video images. In the images, background and noise interference are minimized and likely volatile organic compound (VOC) plumes are isolated using an algorithm. The algorithm determines if an image contains a chemical plume based on a temporal fast Fourier transform (FFT) calculation comparing numerous aligned frames. A chemical plume may generate high frequencies due to flickering characteristics in the atmosphere, yielding high intensity pixels in the processed image. A plume index (PI) is calculated based on the number and intensity of pixels in the processed VOC plume image. If the PI is greater than an experimentally determined threshold value, an action can be triggered, such as an alarm or a video capture for confirmation.

While the LDAR3 system describes a method to use the frequency domain to align video images and remove camera shaking, it does not address complex interferences such as moving equipment, people, vehicles, or steam which can lead to false detections. Accordingly, more accurate plume identification techniques are needed.

### SUMMARY

An embodiment described herein provides a system for autonomous detection of chemical plumes. The system includes a camera capable of generating an image at least at a wavelength of electromagnetic (EM) radiation that is absorbed or emitted by a chemical species and an analysis system configured to analyze a sequence of images from the camera. The analysis system includes a processor; and a non-transitory, computer-readable medium comprising code configured to direct the processor to perform functions. The functions include identifying a plurality of deterministic features and a plurality of probabilistic features of objects in an image, comparing the plurality of deterministic features, or the plurality of probabilistic features, or both, to another image collected at a proximate time, and determining if a change between the compared images represents a chemical plume.

Another embodiment described herein provides a method for autonomously detecting a chemical plume. The method includes obtaining a number of images from a camera at least at a wavelength of light selected to be absorbed or emitted by a chemical species. The images are analyzed to identify changes in a deterministic feature, changes in a probabilistic feature, or both, between sequential images; and recognizing a chemical plume based, at least in part, on the changes.

### DESCRIPTION OF THE DRAWINGS

The advantages of the present techniques are better understood by referring to the following detailed description and the attached drawings, in which:

FIG. 1 is a schematic diagram of an automated gas detection and response scheme, as described herein;

FIG. 2 is a drawing of an IR image of leak site, showing a chemical plume that has formed in an environment;

FIG. 3 is a block diagram of an autonomous detection system that can be used to identify plumes in embodiments;

FIG. 4 is a block diagram of a method that may be used in embodiments to detect a plume;

FIG. 5 is a method of plume detection that may be used in embodiments; and

FIG. 6 is a block diagram of a method for controlling an autonomous detection system, such as discussed in FIG. 3.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

As used herein, a “camera” is a device that can obtain a sequence of two dimensional images or frames (such as a video) in a variety of spectral domains, including but not limited to visible, infrared, and ultraviolet. In an embodiment, a camera forms a two dimensional image of an area in the infrared spectrum, such as between about 2 to 14 micrometers. In another example, a camera forms a two dimensional image of an area in the ultraviolet spectrum, such as between about 350 nm to 400 nm. Any number of other cameras can be used in the present system, depending on the wavelengths desired. The wavelengths can be selected based on the likely chemical species that may be released from a leak in a facility.

A “chemical species” is any compound that may be released in a leak, either as a vapor or as a liquid. Examples of chemical species that may be detected using the systems and techniques described herein include both hydrocarbons and other chemical species. Chemical species that may be detected include but are not limited to hydrocarbon vapors released in a cloud in an LNG plant or other facility or oil forming a slick on top of a body of water. Non-hydrocarbon species that may be detected include but are not limited to hydrogen fluoride gas released as a vapor in refinery, chlorine released as a vapor in a water treatment facility, or any number of other liquids or gases. Chemical species may also be deliberately added to a process stream to enhance the detection of a plume using the techniques described herein.

“Electromagnetic radiation,” or EM radiation, included electromagnetic waves or photons that carry energy from a source. EM radiation is often categorized into spectral ranges by its interaction with matter. As used herein, visible light or the visible spectrum includes light that is detectable by a human eye, e.g., from about 400 nm to about 700 nm. Ultraviolet (UV) light, or the UV spectrum, includes light having wavelengths of around 190 nm to about 400 nm. In the UV and visible spectral ranges, chemical substances may absorb energy through electronic transitions in which an electron is promoted from a lower orbital to a higher orbital. Infrared (IR) light, or the IR spectrum, includes light at wavelengths longer than the visible spectrum, but generally lower than the microwave region. For example, the IR spectrum may include light having a wavelength between about 0.7 and 14 μm in length. At the longer wavelength end of this continuum at about 10 μm to about 14 μm (the far-IR), chemical substances may absorb energy through rotational transitions. At an intermediate wavelength range of about 2.5 μm to about 10 μm (mid-infrared), chemical substances may absorb energy through vibrational transitions. At the lower end of the wavelength range at about 0.7 μm to 2.5 μm (near-IR), chemical substances may absorb energy through vibrational transitions and through similar processes as visible and UV light, e.g., through electronic transitions. Camera images may be formed from electromagnetic radiation in the visible spectrum, IR spectrum, or UV spectrum using a relatively simple detector, such as a charge coupled device (CCD).

As used herein, a “Facility” is a tangible piece of physical equipment through which hydrocarbon fluids are produced from a reservoir, injected into a reservoir, processed, or transported. In its broadest sense, the term facility is applied to any equipment that may be present along the flow path between a reservoir and its delivery outlets. Facilities may comprise production wells, injection wells, well tubulars, wellhead equipment, gathering lines, manifolds, pumps, compressors, separators, surface flow lines, steam generation plants, processing plants, and delivery outlets. Examples of facilities include fields, polymerization plants, refineries, LNG plants, LNG tanker vessels, and regasification plants, among others.

A “hydrocarbon” is an organic compound that primarily includes the elements hydrogen and carbon, although nitrogen, sulphur, oxygen, metals, or any number of other elements may be present in small amounts. As used herein, hydrocarbons generally refer to components found in natural gas, oil, or chemical processing facilities, such as refineries or chemical plants.

As used herein, the term “natural gas” refers to a multi-component gas obtained from a crude oil well (associated gas) and/or from a subterranean gas-bearing formation (non-associated gas). The composition and pressure of natural gas can vary significantly. A typical natural gas stream contains methane (CH₄) as a major component, i.e. greater than 50 mol % of the natural gas stream is methane. The natural gas stream can also contain ethane (C₂H₆), higher molecular weight hydrocarbons (e.g., C₃-C₂₀ hydrocarbons), one or more acid gases (e.g., hydrogen sulfide), or any combination thereof. The natural gas can also contain minor amounts of contaminants such as water, nitrogen, iron sulfide, wax, crude oil, or any combination thereof.

“Substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context.

### Overview

Apparatus and methods are provided herein for autonomously identifying chemical plumes in the air or on a water surface using a sequence of images. The techniques use a software algorithm to analyze the sequence of images to distinguish chemical plumes from other features in a scene to decrease a probability of false alarms. The software algorithm distinguishes the hydrocarbon vapors from other ambient factors such as water flows, steam plumes, furnace off gases, vehicles, persons, wildlife, and the like. The chemical plumes may be identified by deterministic features, statistical features, and auxiliary features, or any combinations thereof. The image may be a grayscale image, in which the difference in contrast is used to identify features.

As used herein, deterministic features include various features of a chemical plume, such as geometric features, e.g., size and shape of the chemical plume, among others, and kinematic features, such as motion constraints, among others. Statistical features include joint temporal features, such as the overlap of an image of a chemical plume in a frame with the image of the chemical plume in previous frames. Auxiliary features include such features as a comparison of the motion of the chemical plume with expected wind direction, with visible video images of a plant, and the like.

The techniques described herein can improve the detection of chemical plumes in hydrocarbon plants, which may help to reduce the probability of leaks remaining undetected for an extended period of time. In some embodiments, an infrared imaging camera is used, since many hydrocarbon species absorb at a wavelength in the IR spectrum.

In some embodiments, a camera is mounted on a poll and can be moved, such as panning and tilting, under the control of a system. Several cameras may be positioned around the perimeter of the plant to give 100% coverage of the facility. This autonomous detection system can provide plant surveillance to be performed on a continuous basis. In some embodiments, the overall system cost may be kept low while keeping the false alarm rate low and still being able to detect small or early hydrocarbon leaks, e.g., plumes with about 20% LEL at a distance of 150 meters subject to environmental conditions.

The detection system can be used in any facility that has hydrocarbons, or other detectable chemical species, present. Examples of such facilities include LNG plants, oil and gas wellhead operations, off shore platforms, transport pipelines, ships, trucks, refineries, and chemical plants. As noted, the chemical plume may be a hydrocarbon or oil slick on a surface of water, such as around an offshore platform, tanker, off-loading platform, and the like.

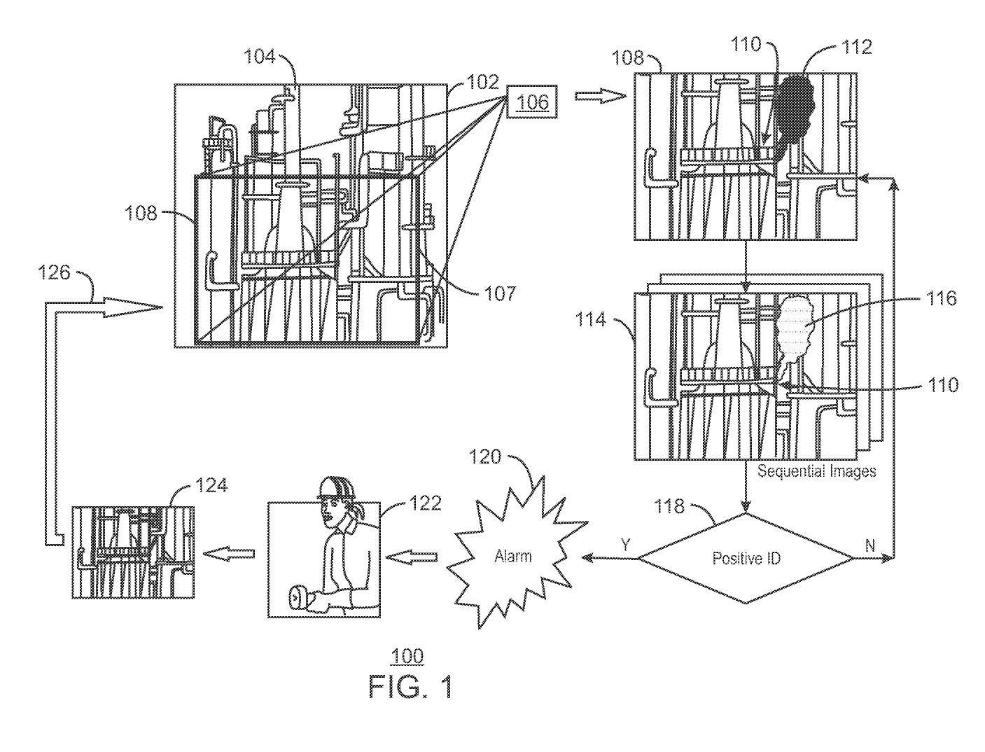

FIG. 1 is a schematic diagram 100 of an automated gas detection and response scheme, as described herein. As shown in the schematic diagram 100, a facility 102 includes equipment 104 that contains chemical species, such as hydrocarbons. A camera 106 is directed to monitor an area 107 of the facility and generate an image 108, for example, imaging the area 107 in the IR spectrum.

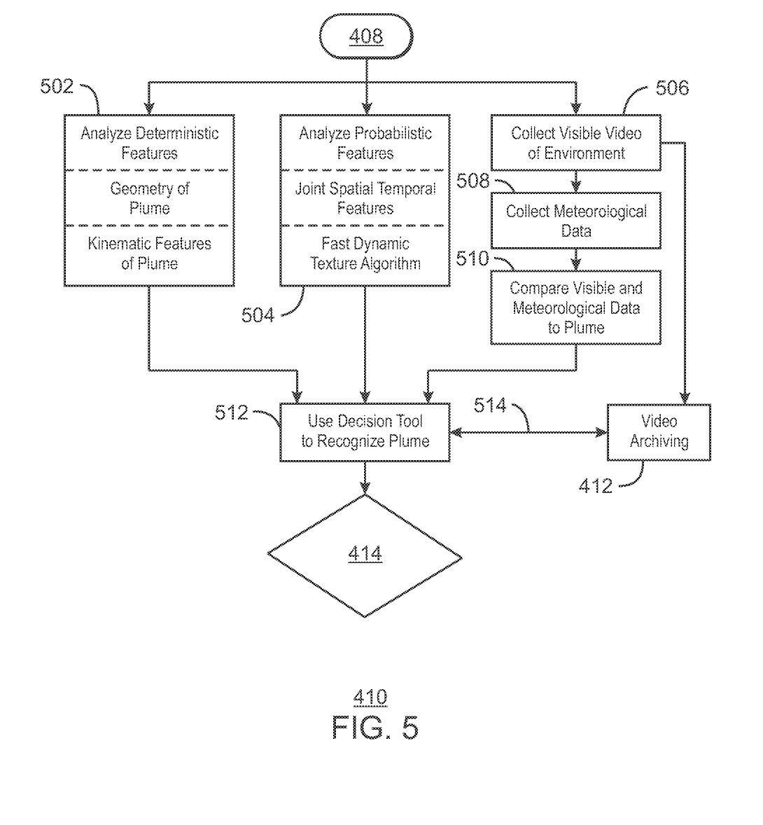

In this example, the image 108 of the area 107 shows the presence of a leak 110, releasing a chemical plume 112. The image 108 could be used to manually determine the presence of the leak, but this may miss leaks due to the monitoring operator stepping away from the monitor, paying attention to other tasks, and the like. In contrast, the chemical plume detection system described herein monitors a sequence 114 of images. As the chemical plume 114 changes to new configurations or shapes 116 the system can identify and locate the leak 110 by using a number of comparisons between the sequential images 108 and 114, as described with respect to FIG. 5, below. If a positive identification of a chemical plume is not made, as indicated at block 118, the system can continue to collect images 108 and 114.

If a positive identification of the leak 110 and chemical plume 112 is made, the system can locate the leak and activate an alarm 120, alerting an operator to send a response team 122 to the site 124 of the leak 110. The response team 122 can confirm the presence of the leak 110 and effectuate repairs. In some embodiments, the hydrocarbon leak may be shown as a false color image for easier operator interpretation. Further, the camera 106 may have zoom capability to assist the operator when doing a leak investigation in manual mode

The system can continue monitoring the area 107, as indicated by an arrow 126. The continuous monitoring may allow the system to be available 24 hours a day, seven days a week, and 365 days per year, i.e., with minimal downtime. Downtime may mainly be the result of performing routine maintenance on the system, and may be compensated for by redundancy, e.g., directing other cameras at an area whose cameras are being serviced.

In some embodiments, the system can be configured to work over a broad temperature range, including cold temperatures and warm, such as a hot, tropical desert environment or a cold, arctic environment. Further, the system may be adapted to function in the day or night and at temperatures ranging from about minus 10° C. to 50° C. The system may also be configured to operate under other environmental interferences, such as in fog, rain, or sandstorms. In various embodiments, the system may detect hydrocarbons, such as methane, ethane, or propane, among others. The system may also be configured to detect other chemical species which can be imaged.

The camera 106 may be pole mounted and, as mentioned, have an automatic pan and tilt capability and 360 degree coverage. In some embodiments, the camera 106 may be able to be operated in both the automatic and manual modes. Thus, in the event of an alarm, an operator may be able to take control of the camera to do further investigation.

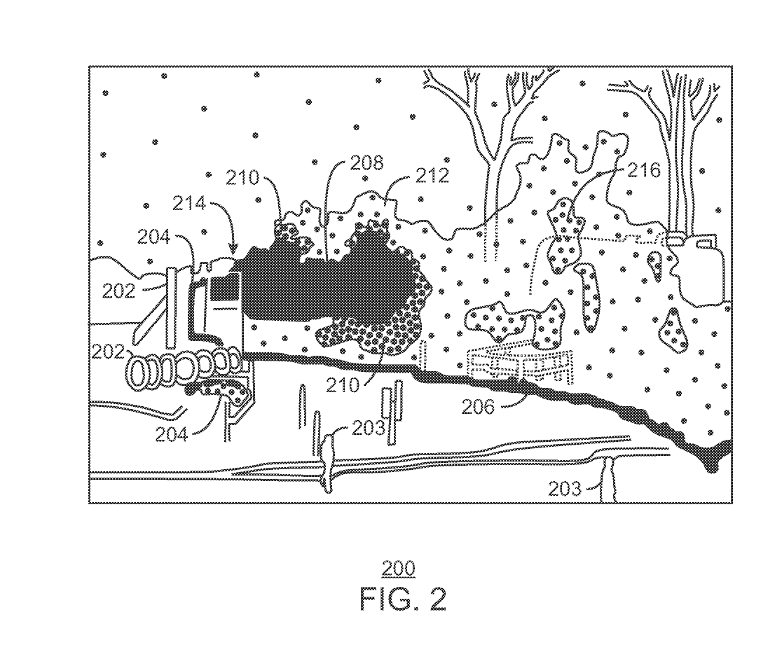

FIG. 2 is a drawing of an IR image 200 of leak site, showing a chemical plume that has formed in an environment. The drawing 200 illustrates some of the issues that are addressed in an automated detection system using the techniques described herein. In the IR image 200, hotter objects are shown as lighter areas and cooler objects are shown as darker areas. Accordingly, depending on the wavelength used for detection, such items as plant equipment 202 and persons 203 are often lighter areas or even white areas. By comparison, cooling water lines 204 or water flows 206 may be darker areas or even black areas. In this environment, a chemical plume 208 may absorb light from the environment at the selected wavelength and, thus, be a dark area in the IR image 200. Depending on concentrations of the chemical species, some regions 210 may be lighter, and other regions 212 may be nearly transparent, for example, as the chemical is diluted in the atmosphere. As the chemical plume 208 moves away from the leak site 214, it may pass in front of equipment 216, partially or completely obscuring of the equipment 216.

The IR image 200 indicates some of the complexities inherent in detecting a chemical plume 208. As persons 203, trucks, and other objects move through the environment, they may trigger false alarms. Further, other moving objects, such as a water flow 206, may have similar absorbance profiles to the chemical plume 208 making distinguishing these objects a challenge.

Thus, the current techniques perform a number of comparisons between sequentially collected images to confirm the presence of a plume. These comparisons include deterministic features, such the geometry and motion of the plume between frames, among others. For example, dynamic texture analysis may be used to identify likely plumes. Dynamic texture analysis is a statistical method that can be used to abstract a feature in an image region. A region in a sequence of images is treated as a data cube, and a statistical model is used to abstract a feature of that data cube. Features that may be abstracted include uniformity of boundary, spatial texture from concentration, and texture evolution over time, among others. Other comparisons that may be useful include statistical features, in which a model of a plume motion is fit to the current plume, for example, using principal component analysis of regions in a segmented image. A visible light video image may be used in comparisons to the IR image 200, for example, to eliminate other types of plumes, such as steam plumes.

### System for Detecting Chemical Plumes

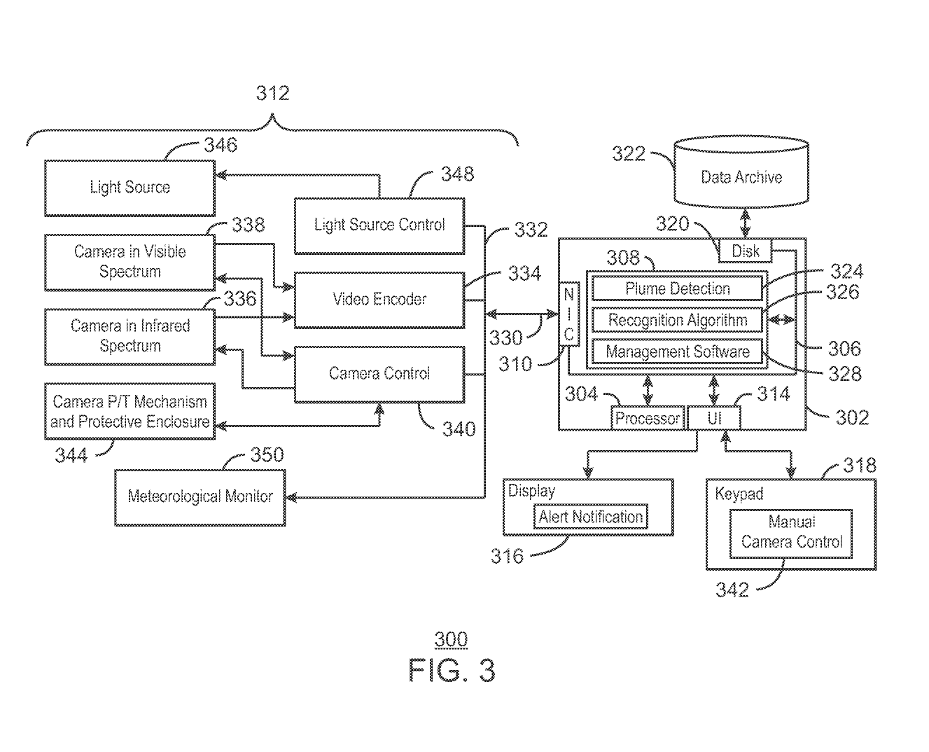

FIG. 3 is a block diagram of an autonomous detection system 300 that can be used to identify plumes in embodiments. The autonomous detection system 300 has a central server 302 that can perform the processing for the autonomous detection system 300. In some embodiments, this function may be divided among multiple servers or may be incorporated into a distributed control system (DCS), and the like. In the central server 302, a processor 304 is linked to a bus 306 to access other devices, such as a computer readable medium 308. The processor 304 may be a single core processor, a multi-core processor, a cluster of processors, or a virtual processor in a cloud computing environment. The computer readable medium 308 can include any combinations of memory, such as read only memory (ROM), programmable ROM, flash memory, and random access memory (RAM), among others. Further, the computer readable medium 308 can include any combinations of devices used for longer term storage of code and results, including hard drives, optical drives, flash drives, and the like.

The central server 302 can use a network interface card (NIC) 310, coupled to the bus 306, to access the detection equipment 312 used to provide functionality to the autonomous detection system 300. A user interface (UI) 314 can be coupled to the bus 306 to provide input and output capability and control to users. For example the UI 314 can interface to one or more display devices 316 and input devices 318. The UI 314 may be integrated into a DCS system, providing plant control in addition to control of the autonomous detection system 300. The central server 302 can also include a disk interface 320, coupled to the bus 306 to provide access to a data archive 322 for longer term storage of data, such as events and videos of leaks. The data archive 322 may include any number of storage systems, such as a hard drive, a storage array, a network attached storage array, or a virtual storage array, among others.

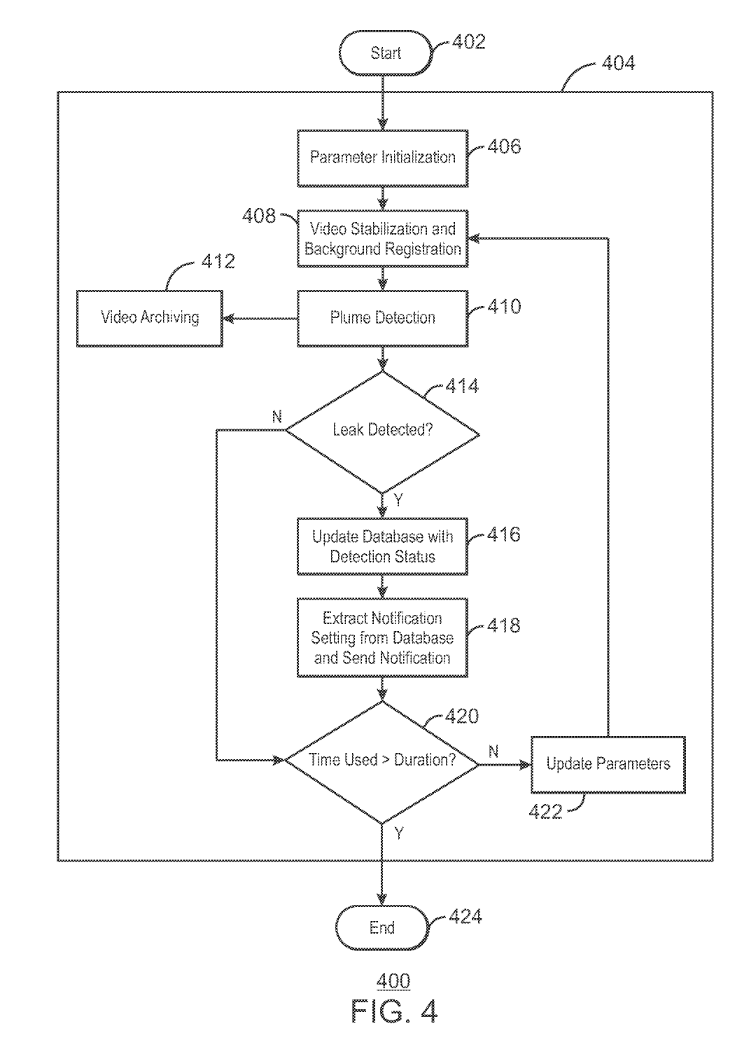

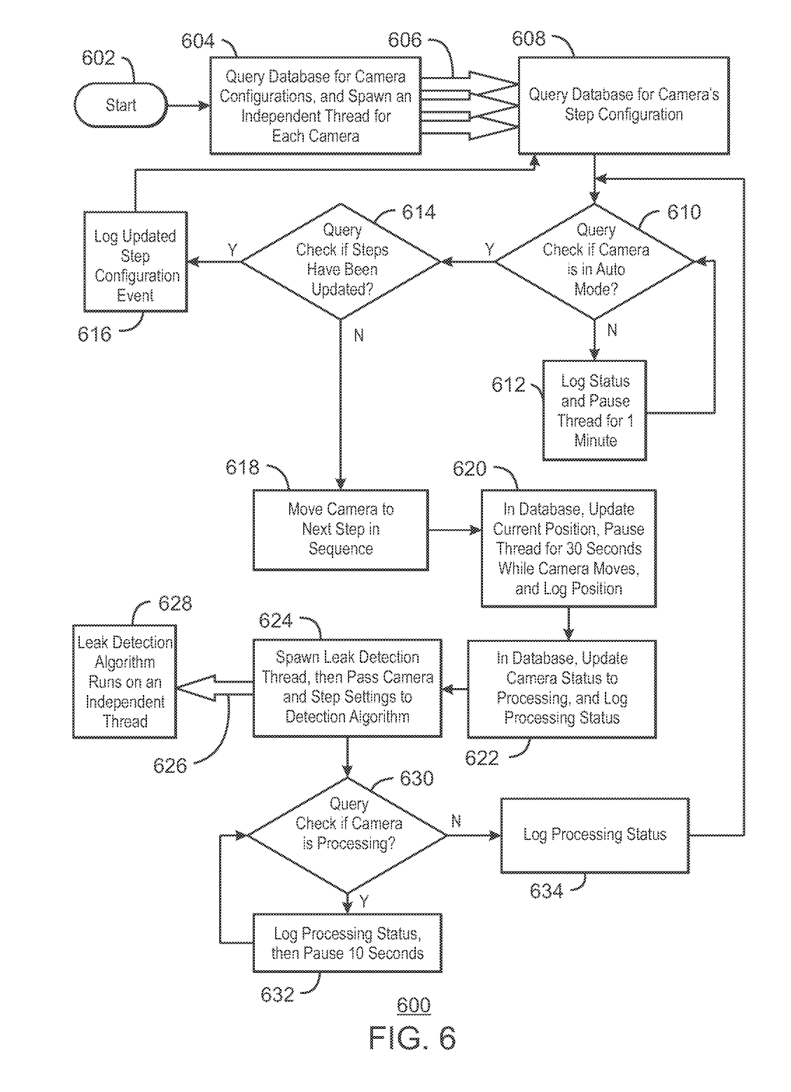

The computer readable medium 308 may store the code used to provide functionality to the autonomous detection system 300. For example, a first module 324 may store code configured to direct the processor 304 to detect changes in successive images that could correspond to chemical plumes, such as the method 410 discussed with respect to FIG. 5. A second code module 326 may provide code to recognize plumes and confirm that the changes between successive images are plumes, such as the method 400 discussed with respect to FIG. 4. A third module 328 can provide management functions, such as controlling the cameras in autonomous detection system 300, such as the method 600 discussed with respect to FIG. 6. The management code may also include code for controlling the system status, examining log files, allowing operator control of the camera position, and the like.

In some embodiments, various methods of data transmission may be implemented between the NIC 310 of the central server 302 and the equipment 312. For example, a communications link 330 to a system network 332 may be wired or wireless. Further, the system network 332 may, itself, be wireless, and each of the individual pieces of equipment can individually communicate with the central server 302 over a wireless communications link 330. The individual pieces of equipment may be powered by a connection to a power grid or may be powered by remote sources, such as batteries, solar panels, and the like.

Any number of individual pieces of equipment 312 may be combined to implement the detection functions of the autonomous detection system 300. For example, a video encoder 334 may accept an input signal from a detection camera 336 that is capable of imaging a chemical species, such as a hydrocarbon vapor, at one or more wavelengths, such as in the infrared spectrum. The video encoder 334 can form a digitized image and send the image back to the central server 302 over the communications link 330. A signal from a camera 338 operating in the visible spectrum may also be sent to the video encoder 334 for transmission back to the central server 302. In an embodiment, the camera in the infrared spectrum 336 and the camera in the visible spectrum 338 are mounted together and aligned to form overlapping images of an area in an environment. In an embodiment, the cameras 336 and 338 are mounted separately, but can be directed to form overlapping images of the environment.

The cameras 336 and 338 can be controlled by a camera control 340, which may allow the cameras to zoom, focus, and perform other functions, such as calibration. The camera control 340 can be in communication with the central server 302 which can automatically focus, zoom, and the like. In an embodiment, a manual camera control 342, for example, in a human machine interface, is used to control the cameras 336 or 338, for example, using a joystick and keypad. The manual inputs may then be passed to the camera control 340 by the central server 302. The cameras 336 and 338 may also be moved by the camera control 340, for example, using a pan and tilt mechanism 344 mounted in a protective enclosure with the camera 336 or 338. The protective enclosure may include other functions, such as a cooling function, a defogging function, and the like, which can be activated manually or automatically using the camera control 340.

The autonomous detection system 300 is not limited to ambient energy for the detection. In some embodiments, a light source 346 may be used to illuminate the environment. For example, an IR laser may be used to illuminate an area of interest for leak confirmation. The light source 346 may be useful in conditions in which the contrast between a plume and the background may not be sufficient to distinguish the chemical species. The light source 346 may be powered, activated, or moved using a light source control 348 in communication with the central server 302.

The autonomous detection system 300 is not limited to the detection of chemical plumes, but may also provide other functionality. For example, in an embodiment, the autonomous detection system 300 may be used to monitor specific equipment, such as furnaces, reactors, compressors, and the like, looking for such problems as hot spots, maldistribution, hot motors, and the like. Further, the autonomous detection system 300 may provide fence-line monitoring, for security purposes, and monitoring of fugitive emissions from the equipment in the environment.

The detection and confirmation of plumes may be enhanced by meteorological measurements collected by a meteorological monitor 350. The meteorological monitor 350 may collect data on environmental conditions such as wind speed, temperature, precipitation, atmospheric haze, and the like. This data may then be used in embodiments to confirm that a detected plume is consistent with the collected data.

### Method for Detecting Chemical Plumes

FIG. 4 is a block diagram of a method 400 that may be used to detect a plume in embodiments. The method 400 starts at block 402 by spawning a processing thread to perform a series of functions on a streaming sequence of images from a camera. The thread can be passed initialization variables, such as a pointer to a video stream, a camera identification, a step (or location) identification, a sensitivity setting, and a time duration, among others. As indicated in block 404, the series of functions are performed for each frame in the sequence of images, starting at block 406 with the initialization of parameters for the frame analysis.

At block 408, the image is stabilized, for example, by performing a transformation algorithm on the image to match common feature points with those in a previous frame. This may be performed by using a feature point method, for example, based on the Kanade-Lucas-Tomasi (KLT) algorithm, or region based registration methods. False alarms originated from imperfect registration can be filtered out by an image mask comprised of edges. The edges may be identified by a number of techniques, such as a Canny edge detector. The Canny edge detector may use an adaptive threshold selection method, for example, using Tsai's moment-preserving algorithm. The stabilization removes noise that could result from vibrations, such as changes in wind speed, plant equipment, and the like. Background registration is performed at this block to remove features that are part of every frame, such as plant equipment.

Once background features are identified, they may be removed. In some embodiments the system performs a background adaptive algorithm that may preliminarily classify pixels into foreground and background and then apply fast and slow adaptation modes respectively. A fast adaption mode quickly removes an object that is identified as being part of the background, while a slow adaption mode continues to monitor the pixels in question over a longer period of time.

The background registration function may remove objects that have solid edges or are moving through the frames by certain amounts, such as persons, vehicles, and the like. This may be performed by using affine transformation model to fit the geometric changes between image frames and using random sample consensus (RANSAC) to remove outliers. In an embodiment, the Canny edge detector is used to identify objects that have a fixed set of edges. As plumes may have random edges, fixed edges may indicate objects that can be removed.

Generally, the methods mentioned above compare the shape, movement, and edges of objects between frames to identify objects that are not plumes. To begin, objects that should be removed do not change significantly in size, e.g., expand or contract, between sequential frames. Further, the objects that can be removed may be moving in a direction and speed that can be predicted from a sequence of frames, i.e., not in a random fashion. For example, a scoring system may be used to score polygons in frames that may be related, such as similar shapes that are offset be a certain amount. The objects may also have non-random outlines, i.e., not substantially changing from frame to frame. Although a vehicle or person may turn in view of the cameras, changing the profile shown, the changes in the outline and size may not be as significant as the change in an expanding plume. Accordingly, an object that meets these tests can be marked as a background object and removed from the frame. The registration and edge detection process identifies changes that may be further analyzed to determine if a plume exists. If no plume exists, the registered image may be blank.

The algorithms may also segment each frame into groups of pixel for the plume analysis. For example, pixel-wise statistical analysis methods may be applied to the image segmentation. Further, pixel features can be extracted from a neighborhood region, including size, number of corners, number of edges, and aspect ratio.

At block 410, algorithms may be used to detect and confirm plumes, as discussed in greater detail with respect to FIG. 5. If a possible plume is detected, the video images may be archived for reference at block 412, for example, in the data archive 322 discussed with respect to FIG. 3. The archived video images may include both raw and processed data from cameras in multiple spectrums, such as infrared and visible, which may be indexed and retrieved for gas leak detection purposes. The results for the detection algorithm can be improved by using archived IR video clips, for example, to train decision tools, as discussed with respect to block 512 of FIG. 5. If a plume is detected and confirmed, this indicates that a leak has been detected. If a leak is detected at block 414, process flow proceeds to block 416.

At block 416, a database is updated with the detection status. The database may, for example, reside in the data archive 322. At block 418, the central server 302 or a DCS may extract notification settings from the database, such as persons to be notified of leak events and send out process alarms, e-mails, text messages, pages, radio messages, and the like. In an embodiment, images of the plume are sent to the notified persons. The images may include video sequences of the plume or may be single still shots. The later may be useful when a picture message is sent to a user's mobile phone, as bandwidth limitations may make sending video clips problematic.

After block 418, process flow proceeds to block 420. Further, if no leak is detected at block 414, process flow proceeds directly to block 420. At block 420, an elapsed time for the detection sequence is checked against a time duration parameter. If the elapsed time is lower than the time sequence, at block 422 the parameters are updated, for example, incrementing the elapsed time, and process flow returns to block 408 to continue the analysis for the next frame.

If at block 420, the elapsed time is greater than the time duration parameter, the process exits and terminates at block 424, with the release of memory and resources. Upon exiting, the method 400 may also indicate that the camera is no longer processing or busy. This indication may allow the camera to be automatically moved to a new location, prior to being restarted. A camera control sequence is discussed further with respect to FIG. 6.

FIG. 5 is a method 410 of plume detection that may be used in embodiments. The method 410 begins when process control is passed from block 408. The method 410 can follow multiple paths, for example, in a parallel fashion, performing analyses of deterministic features, statistical features, and auxiliary features, such as meteorological data and images from cameras in the visible spectrum.

At block 502, an analysis of deterministic features is performed. This may include both spatial and kinematic features, among others. For example, the analysis may determine geometric features, including the shape of a chemical plume or the size of a chemical plume. The analysis may also determine shape constraints such as aspect ratio, disperseness (e.g., the thickness of the plume as a function of distance), convexity, and histogram of orientation gradient (HOG) of contour, among others. These features serve as constraints and provide a pre-screening of the potential objects.

Kinematic or motion features may be part of the analysis, such as determining that a plume is constantly moving, but that the motion is restricted to a constrained area, as expected by a plume originating from a leak. Kinematic features can include size constraints of a plume, such as a minimal and maximal size through a sequence of images. The kinematic features can be used to filter out most rigid body interferences.

At block 504, probabilistic features of the plume can be analyzed. For example, a probabilistic feature can include a spatial pattern of the chemical plume, a temporal pattern of the chemical plume, or any number of other features. The analysis may include joint spatial and temporal analyses such as a fast dynamic texture algorithm. In the probabilistic analysis a statistical model described by two types of equations, e.g., evolution equations and observation equations, which respectively model the way the intrinsic state evolves with time and the way the intrinsic state projects to image pixels, may be fitted to the segmented pixel data. Parameters can be estimated by matrices. Other probabilistic analysis techniques may also be used, such as principal component analysis (PCA). In PCA, a determination of the variables causing changes to a plume is made, such as a statistical comparison of wind speed and direction with changes seen in plumes.

Other data may be collected to assist in the recognition and confirmation of plumes. At block 506, a sequence of visible images, or a video stream, may be captured of the leak environment. If a plume is suspected to be present, the visible images may be stored in the video archive, as indicated at block 412. In addition, meteorological data may be collected 508 for the environment, as previously noted.

At block 510, the extra data can be compared to the plume identified using the non-visible images, such as images in the IR spectrum. For example, the visible images may be used to differentiate organic vapor plumes and water steam. Generally, organic plumes may be dark in the non-visible images and not very visible in the visible images. In contrast, a steam plume may be bright in the non-visible images, due to emitted heat, and visible in the visible images. In addition to improving the detection, the visible images may be used to locate the leak in the plant environment, for example, by comparing a registered image from camera in the infrared spectrum with an overlapping image from a camera in the visible spectrum.

The gas plume detection can also be improved or confirmed by using data from meteorological monitor. For example, the calculated motion of the plume may be compared with the wind direction, such as in a PCA algorithm. If the motion of the plume is inconsistent with the wind direction, the plume identification may be incorrect. Each of the algorithms discussed with respect to blocks 502, 504, and 510 may generate a numerical measurement corresponding to whether a plume is real or not.

At block 512, the data from each of blocks 502, 504, and 510 is used in a decision tool to confirm the presence of a plume. The decision tool may be a support vector machine (SVM) used as a non-binary linear classifier. In the SVM, results from multiple iterations of blocks 502, 504, and 510, for example, using simulated plumes or recorded plume data, are used to generate a hyperplane in the decision space. One side of the hyperplane corresponds to a confirmed plume, while the other side of the hyperplane corresponds to no plume. In operation, the SVM calculation can generate a number that corresponds to whether the plume is on one side or the other, providing a determination of whether the plume is confirmed.

Other machine learning techniques may be used as the decision tool instead of, or in addition to, the SVM. For example, a neural network may be trained to recognize plumes in the plant environment using controlled releases of vapor to simulate plumes or recorded plume data. Other techniques may use a similarity measure between matrices from observations and database.

FIG. 6 is a block diagram of a method 600 for controlling an autonomous detection system, such as discussed in FIG. 3. The method 600 can be used to integrate the methods of FIGS. 4 and 5 into a single control scheme for automatically detecting chemical plumes and identifying leaks. Referring also to FIG. 3, the method 600 starts at block 602 with the initialization of the server application, for example, on the central server 302, in a DCS, or on other plant systems. At block 604, a database, for example, a SQL database stored in the data archive 322, can be queried to determine the camera configuration data for the autonomous detection system 300. Such configuration data may include numbers of cameras, types of cameras, locations of cameras, and other information, such as access parameters for a meteorological station. A separate processing thread 606 is spawned for each of the cameras, such as the camera in the infrared spectrum 336 and the camera in the visible spectrum 338. It will be clear to one of skill in the art that the following blocks are operating in parallel for each of the cameras in the autonomous detection system 300. Further, an autonomous detection system 300 may have a significant number of cameras in an environment, such as three or more cameras 336 which may be operating at a number of wavelengths, and three or more visible cameras 338 overlapping the field of view.

At block 608, the database can be queried for a camera's step configuration. The step configuration represents the position of the camera system, such as set by the camera pan and tilt mechanism 344. After a step is taken, the camera may stop and scan for plumes. At block 610, a determination is made as to whether the camera is in automatic mode. If not, process flow proceeds to block 612, where the status is logged and the thread is paused, for example, for one minute. Process flow returns to block 610 after the pause to again check if the camera is in automatic mode. In an embodiment, after a selected number of iterations, such as 2, 3, 4, or 5, the camera may be returned to automatic mode by the autonomous detection system 300, to avoid accidently being left in manual mode. If the camera is determined to be in automatic mode at block 610, process flow proceeds to block 614.

At block 614, the database is queried to determine if the steps have been updated, for example, if a smaller or larger motion between the scans has been selected. If so, process flow proceeds to block 616, which logs the step configuration event. Process flow then returns to block 608 to retrieve the new step configuration. If the step configuration has not been updated at block 614, process flow proceeds to block 618. At block 618, the camera is moved to the next step in the sequence. At block 620, the current step is logged as the new camera position and the thread is paused for a certain period of time while the camera moves. At block 622, the camera status is updated in the database to processing and this update is logged. At block 624, a leak detection thread 626 is spawned for the camera, activating a leak detection algorithm 628. The leak detection algorithm 628 may use the method 400 discussed with respect to FIG. 4. During the time that the leak detection algorithm 628 is operational, the camera status can be maintained as processing. When the leak detection algorithm 628 terminates, the camera status may be changed to not processing.

At block 630, a determination may be made as to whether the camera is processing (busy). If the camera is processing, at block 632 the processing status is logged and the camera control thread, i.e., method 600, is paused, for example, for 10 seconds, before returning to block 630 to repeat the check of the processing status. If the processing status has changed, and the camera is no longer processing, e.g., the leak detection algorithm has terminated, process flow proceeds to block 634. At block 634, the change of the camera to a status of not processing is logged, and process flow returns to block 610 to restart the method 600.

A number of variations may be used in embodiments to improve the reliability, ease of use, or ease of implementation of the autonomous detection system 300. In an embodiment, leak modeling results, leak detection criteria, camera and lens characteristics, and algorithm requirements, may be combined to form deployment reference charts for setting up the autonomous detection system 300.

The reliability of the autonomous detection system 300 may be tested manually or automatically by a controlled release of hydrocarbons. The detection of the plume from the controlled release may verify that the autonomous detection system 300 is in good working condition.

The detection reliability may also be improved by utilizing chemical markers in various hydrocarbon streams. The chemical markers may be substances added to increase an absorbance or emission at a particular wavelength. Such markers may make the use of other detection techniques more useful. For example, fluorescent chemicals may be added to a hydrocarbon stream in very small amounts, such as a few parts-per-million, as these compounds often have a high quantum yield, which is the number of photons emitted, divided by the number of photons absorbed. As the wavelength of light emitted may not overlap with natural sources, the identification of a plume from the fluorescence may be straightforward.

The methods described above do not have to be used in isolation. Point source monitors may be integrated with the autonomous detection system for confirmation of an alert. Further, multiple camera views and laser range finders may provide leak confirmation by triangulation of areas of interest.

The autonomous detection system 300 is not limited to pole mounted cameras. In embodiments, the cameras may be pole mounted, attached to autonomous mobile platforms, placed on conveniently located towers, or suspended from cables or balloons. The autonomous detection system 300 may also be integrated into mobile robots, which are either autonomous or steered by an operator.

Further, in one or more additional embodiments, the system may also include gas detection equipment that may be utilized along with the autonomous detection system. This embodiment may include one or more gas detection transmitters that communicate via a wireless medium or through a wired connection to a gas detector control device and/or to one of the devices in the autonomous detection system. For example, the gas detection transmitters may be distributed around a facility at various locations, such as adjacent to equipment, pipe couplings or flange. The gas detection transmitters may be configured to detect one or more components within the area near pipe couplings or flanges. Accordingly, the gas detection system may be utilized to provide additional information to the autonomous detection system to further enhance the determination of the leak location and/or may be used as a separate leak detection system.

The gas detection system may include one or more gas detection transmitters to provide this enhancement. For instance, the gas detection system may include wireless communication and/or physical communication; may capture samples at a predefined rate. The gas detection transmitters in the system may be configured to transmit an indication once a threshold has been exceeded and/or once a change in the composition of the sampled gas has changed from a previous sample by a specific amount. In another embodiment, the system may be configured to display an indication to a control unit and an alarm may be presented once a change in the composition of the sampled gas has exceeded a threshold or has varied between samples above a specific amount.

In one or more embodiments, the devices of the system may utilize one or more different power sources, such as solar power, battery power and/or facility provided power, to maintain operation despite various in conditions. As an example, the gas detection transmitters may be configured to utilize solar and battery power to lessen reliance on physical cabling and power supplied by equipment at the facility.

While the present techniques may be susceptible to various modifications and alternative forms, the embodiments discussed above have been shown only by way of example. However, it should again be understood that the techniques is not intended to be limited to the particular embodiments disclosed herein. Indeed, the present techniques include all alternatives, modifications, and equivalents falling within the true spirit and scope of the appended claims.

### Embodiments

An embodiment described herein provides a system for autonomous detection of chemical plumes. The system includes a camera capable of generating an image at least at a wavelength of electromagnetic (EM) radiation that is absorbed or emitted by a chemical species and an analysis system configured to analyze a sequence of images from the camera. The analysis system includes a processor; and a non-transitory, computer-readable medium comprising code configured to direct the processor to perform functions. The functions include identifying a plurality of deterministic features and a plurality of probabilistic features of objects in an image, comparing the plurality of deterministic features, or the plurality of probabilistic features, or both, to another image collected at a proximate time, and determining if a change between the compared images represents a chemical plume.

In some embodiments, a deterministic feature can include a geometric feature of the chemical plume. A geometric feature can include a size of the chemical plume, a shape of the chemical plume, an edge of the chemical plume, or any combinations thereof.

In some embodiments, a probabilistic feature can include a kinematic feature of the chemical plume. A kinematic feature can include a motion of the chemical plume, a change in size of the chemical plume, a shape of the chemical plume, or a location of the chemical plume, or any combinations thereof. A probabilistic feature may be a spatial pattern of the chemical plume, or a temporal pattern of the chemical plume, or both.

In an embodiment, the wavelength of light is in the infrared wavelength range. For example, the wavelength of light may be between about 3.1 μm and 3.6 μm. In some embodiments, the wavelength of light can be in the ultraviolet wavelength range. In some embodiments, the wavelength of light can be in the visible wavelength range.

The system can include a distributed control system configured to accept an alarm signal from the analysis system. A human machine interface can be configured to aim the camera at a location.

The system can include a meteorological measurement system configured to collect data on meteorological conditions. The meteorological conditions can include a humidity measurement, a temperature measurement, an insolation measurement, or any combinations thereof.

The chemical species that can be imaged by the system can include a hydrocarbon. For example, the chemical species can include methane, ethane, ethylene, propane, propylene, or any combinations thereof. The chemical species is a liquid hydrocarbon forming a plume on the surface of a body of water.

Another embodiment described herein provides a method for autonomously detecting a chemical plume. The method includes obtaining a number of images from a camera at least at a wavelength of light selected to be absorbed or emitted by a chemical species. The images are analyzed to identify changes in a deterministic feature, changes in a probabilistic feature, or both, between sequential images; and recognizing a chemical plume based, at least in part, on the changes.

In an embodiment, the method can include obtaining a second group of images from a visible camera, wherein the second group of images is of an area proximate to the area imaged by the detection camera. In this embodiment, the second plurality of images is overlapped the plurality of images from the detection camera to determine a location of the chemical plume.

The method can include illuminating an area with an illumination source at least at the wavelength of light selected to be absorbed by the chemical species and obtaining the images from the detection camera from the sample space.

If a chemical plume is recognized in the stream of images from the detection camera, a message can be sent to a remote location. The images from the detection camera can be compared to location data to identify a location of the chemical plume.

In an embodiment, analyzing the stream of images includes reducing the stream of images to numerical data, wherein the numerical data includes a numerical table of frame-to-frame comparisons of frames from the sequence of image data. A neural network may be trained to recognize the chemical plume from a numerical table generated from the plurality of images.

What is claimed is:

1. A system for autonomous detection of chemical plumes, comprising:
a camera capable of generating an image at least at a wavelength of electromagnetic (EM) radiation that is absorbed or emitted by a chemical species; and
an analysis system configured to analyze a sequence of images from the camera, comprising:
a processor; and
a non-transitory, computer-readable medium comprising code configured to direct the processor to:
identify a plurality of deterministic features and a plurality of probabilistic features of objects in an image;
compare the plurality of deterministic features, or the plurality of probabilistic features, or both to another image collected at a proximate time; and
determine if a change between the compared images represents a chemical plume.

2. The system of claim 1, wherein a deterministic feature comprises a geometric feature of the chemical plume.

3. The system of claim 2, wherein the geometric feature comprises a size of the chemical plume, a shape of the chemical plume, an edge of the chemical plume, or any combinations thereof.

4. The system of claim 1, wherein a probabilistic feature comprises a kinematic feature of the chemical plume.

5. The system of claim 4, wherein the kinematic feature comprises a motion of the chemical plume, a change in size of the chemical plume, a shape of the chemical plume, or a location of the chemical plume, or any combinations thereof.

6. The system of claim 1, wherein a probabilistic feature comprises a spatial pattern of the chemical plume, or a temporal pattern of the chemical plume, or both.

7. The system of claim 1, wherein the wavelength of light is in the infrared wavelength range.

8. The system of claim 1, wherein the wavelength of light is between about 3.1 μm and 3.6 μm.

9. The system of claim 1, wherein the wavelength of light is in the ultraviolet wavelength range.

10. The system of claim 1, wherein the wavelength of light is in the visible wavelength range.

11. The system of claim 1, comprising a distributed control system configured to accept an alarm signal from the analysis system.

12. The system of claim 1, comprising a human machine interface configured to aim the camera at a location.

13. The system of claim 1, comprising a meteorological measurement system configured to collect data on meteorological conditions.

14. The system of claim 13, wherein the meteorological conditions comprise a humidity measurement, a temperature measurement, an insolation measurement, or any combinations thereof.

15. The system of claim 1, wherein the chemical species comprises a hydrocarbon.

16. The system of claim 1, wherein the chemical species comprises methane, ethane, ethylene, propane, propylene, or any combinations thereof.

17. The system of claim 1, wherein the chemical species is a liquid hydrocarbon forming a plume on the surface of a body of water.

18. A method for autonomously detecting a chemical plume, comprising:
obtaining a plurality of images from a detection camera at least at a wavelength of light selected to be absorbed or emitted by a chemical species;
analyzing the plurality of images to identify changes in a deterministic feature, changes in a probabilistic feature, or both, between sequential images; and
recognizing a chemical plume based, at least in part, on the changes.

19. The method of claim 18, comprising:
obtaining a second plurality of images from a visible camera, wherein the second plurality of images is of an area proximate to the area imaged in plurality of images from the detection camera;
overlapping the second plurality of images with the plurality of images from the detection camera to determine a location of the chemical plume.

20. The method of claim 18, comprising:
illuminating an area with an illumination source at least at the wavelength of light selected to be absorbed by the chemical species; and
obtaining the plurality of images from the detection camera from the sample space.

21. The method of claim 18, comprising, if a chemical plume is recognized in the plurality of images from the detection camera, sending a message to a remote location.

22. The method of claim 18, comprising comparing the plurality of images from the detection camera to location data to identify a location of the chemical plume.

23. The method of claim 18, wherein analyzing the plurality of images comprises reducing the stream of images to numerical data, wherein the numerical data comprises a numerical table of frame-to-frame comparisons of frames from the sequence of image data.

24. The method of claim 23, comprising training a neural network to recognize the chemical plume from the numerical table.
